(19) United States
(12) Patent Application Publication
(10) Pub. No.: US 2016/0048656 A1
(43) Pub. Date: Feb. 18, 2016

(54) SYSTEM FOR USING MEDICATION SAMPLES TO MEASURE MEDICATION ACQUISITION AND IMPROVE PATIENT OUTCOMES

(71) Applicant: Global Pharmaceutical Services, LLC, Shrewsbury, NJ (US)

(72) Inventors: Christopher Di Lascia, Shrewsbury, NJ (US); Francis Di Lascia, Shrewsbury, NJ (US); Raman Kapur, Shrewsbury, NJ (US); Wilfred Shearer, Shrewsbury, NJ (US); Edward Sadowski, Shrewsbury, NJ (US)

(73) Assignee: Global Pharmaceutical Services, LLC, Shrewsbury, NJ (US)

(21) Appl. No.: 14/827,988

(22) Filed: Aug. 17, 2015

Related U.S. Application Data
(60) Provisional application No. 62/037,729, filed on Aug. 15, 2014.

(51) Int. Cl. G06F 19/00

(52) U.S. Cl. CPC G06F 19/3456; G06F 19/3406

(57) ABSTRACT

Systems, apparatuses, and methods for measuring the acquisition of a medical product by a patient are disclosed. The systems and apparatuses, including databases and associated software modules, perform a method that includes receiving a data comprising a tracking code for the medical product and patient specific information, creating an electronic patient specific data file in a database corresponding to the tracking code and the patient information, activating at least one patient care module from a series of patient care modules that collects patient's information from a user, developing personalized patient monitoring parameters, receiving a second set of data associated to the patient's interaction with one or more patient care modules, evaluating the second set of data against the personalized patient monitoring parameters, generating a feedback action plan for the user that measures patient's adherence to medical products and/or patient care modules, and triggering an user authorized intervention.

### CROSS-REFERENCE TO RELATED APPLICATION

This application claims priority to U.S. Provisional Patent Application Ser. No. 62/037,729, filed Aug. 15, 2014, the disclosure of which is incorporated herein by reference in its entirety.

### BACKGROUND OF THE INVENTION

Embodiments include systems, apparatus, devices and methods for employing medication samples in monitoring and measuring acquisition pattern of medical products and further trigger patient specific interventions to improve health outcomes.

Healthcare providers (hospitals, health systems, accountable care organizations, physicians and medical professionals, and other healthcare providers), payers (insurers, employers and government) and manufacturers (Pharmaceutical, Biotech, Device) all have a vested interest in medication adherence and improved health outcomes for patients.

Medication management has been identified as a key factor in patient outcomes. This includes medication access, acquisition, and adherence. It is estimated that about 40% of patients are non-adherent to prescription medications, and up to 20% of all new prescriptions are never filled. Such poor medication management typically leads to poor patient outcomes and subsequently higher health care cost. For example up to 14% of patients with acute coronary syndromes discontinue antiplatelet medication within 30 days post-procedure, increasing their risk of adverse events 2-fold compared with patients who filled their antiplatelet prescriptions at discharge. Similarly, up to 40% of diabetics report using less of their medication than prescribed because of the cost, resulting in substantially higher A1C levels than compliant patients. Such non-compliance leads into serious diabetic symptoms, worsening of the physical and mental functioning.

There is also no doubt that poor medication management has a negative impact on the economics of the health care with about $290 billion wasted directly from prescription abandonment. In addition, 19% of Medicare institutional discharges are followed by an adverse event within 30 days, from which ⅔ are from preventable drug related events. The inability of patients to take their medication as directed is a factor in 10-25% of hospital and nursing home admissions. The Boston based Institute for Health Improvement (IHI) believes up to 46% of readmissions could be prevented if an effective pharmacotherapy can be implemented to tackle the issue of medication mismanagement.

Given the need for healthcare return on investment, as measured by the impact on patient outcomes for each dollar spent, providers are in need of tools to drive positive patient outcomes by minimizing prescription abandonment and maximizing medication adherence.

Medical Samples are medical products such as a sample or starter pack of medication or a medical device, provided to patients during the interim period prior to acquisition of the full prescription or medical device order. They are typically in a unit pack that is intended to promote the sale of the product and typically have a positive effect on patient acquisition of medication or other treatments.

Until now, a direct link between the sample and the actual acquisition of sampled medical product by patients has never been established. In the past indirect measures, such as “sample to script ratio,” were employed to determine if any a sample product is converted into actual acquisition of such product. As such, in at least the case of medications, healthcare providers and product manufacturers have relied on the sample to script ratio measurement, calculated by the number of prescriptions written by a prescriber divided by the number of samples provided to a given prescriber, as a way of appraising the conversion of medication sampling to the actual acquisition of the sampled medication.

While this methodology may provide a measurement of the number of prescriptions written, it does not capture how many of those written prescriptions are actually filled and acquired by the patients for whom they are written. Furthermore, assessing patient's therapeutic outcome while on the same therapeutic regimen, if not inaccurate, was illusive at best. Therefore, there is a need in the art to equip product manufacturers with a tool to ascertain the success of their product sampling programs, as well as empowering health care providers to accurately measure and assess the role of medical samples in patient outcomes.

### SUMMARY OF THE INVENTION

The present invention addresses the shortcomings in the prior art by describing a process and a system that establishes a direct link between the providing of a medical sample product to a patient and the actual acquisition of such medical products by the patients thereby improving patient therapeutic outcome. In another aspect, the present invention provides for a process and an integrated system of technology and patient services to advance positive patient outcomes.

Embodiments concern implementing systems/apparatus and methods for tracking medical products acquisition patterns and further improving health outcomes. In at least one embodiment, the system/device includes a terminal configured to capture patient specific, a data processor, and a computer readable medium. The computer readable program may be configured to store program instructions which, when activated and executed, cause the processor to measure, track or monitor the acquisition of medical products by a patient. The invention is further intended to personalize a patient care plan based on the type of medical products acquired.

In at least one aspect of the present invention, systems for measuring the acquisition of a medical product by a patient is described, wherein the system comprises one or more microprocessor components programmed to: (1) receiving a first set of data comprising a tracking code for the medical product and patient specific information, (2) creating an electronic patient specific data file in a database corresponding to the tracking code and the patient information, (3) activating at least one patient care module from a series of patient care modules, wherein at least one module collects patient's information from a user and/or said patient, (4) developing personalized patient monitoring parameters, (5) receiving a second set of data comprising information associated to the patient's interaction with one or more of said patient care modules, (6) evaluating the second set of data against the personalized patient monitoring parameters, (7) generating a feedback action plan for the user, wherein said feedback action plan measures patient's adherence to said medical product and/or said patient care modules, and (8) triggering an user authorized intervention. In one embodiment, the developing of personalized patient monitoring parameters may trigger a direct patient care intervention. In one embodiment, the activation step may immediately be followed by an early intervention, such as delivery of a prescribed medical product.

In another embodiment, the medical product may be a pharmaceutical product, a prescription or a non-prescription medication, a medical device product, a dietary product, a health and fitness product or any combinations thereof. In one selective embodiment, the pharmaceutical product is a wellness kit comprising a sample medication, and a tracking code to initiate or activate the system. In one embodiment, the kit contains a prescription order from the physician to the recipient of the kit, for the same medication sampled in the kit.

Another aspect of the present invention is directed towards methods that are performed by an electronic circuit for tracking sample medical products, the method comprising (1) providing to a patient a sample medical product kit comprising a sample medical product and a corresponding tracking code, (2) receiving a first set of data comprising the tracking code of the medical product and patient specific information, (3) creating an electronic patient specific data file in a database corresponding to the tracking code and the patient information, (4) activating a series of patient care modules, wherein each one of said modules collects said patient information from a user and/or said patient, (5) developing personalized patient monitoring parameters, (6) receiving a second set of data comprising information associated to the patient's interaction with the one or more of said patient care modules, (7) evaluating the second set of data against the personalized patient monitoring parameters, and (8) generating a feedback action plan for the user, wherein said feedback action plan measures patient's adherence to said medical product. In yet another embodiment, the present invention includes a step of triggering a user preauthorized intervention.

In yet another aspect of the invention, a computer readable medium is configured to store program instructions which, when executed, cause the processor to link a sample medical product or kit to a personalized patient care plan comprising one or more patient care module(s) wherein each module corresponds to a series of health related databases operable by separate instructions. As such, at least one set of instructions link patient specific information to series of monitoring parameters. In yet another embodiment, instructions are provided to compare the monitoring parameters against a second set of patient specific information that relates to patient's behavior while being managed by the sample medical product or kit. Subsequently, the instructions when executed, link the result of such comparison to triggering of one or more preauthorized intervention(s) applicable to the patient.

### BRIEF DESCRIPTION OF THE DRAWINGS

Embodiments will be described with reference to the following drawing figures, in which like numerals represent like items throughout the figures, and in which:

FIG. 1 is a system diagram showing the activation of the sample medical product, such as a wellness kit, the acquisition of the system and the patient tracking platform.

FIG. 2 is a block diagram of an activated patient care modules showing an implementation of the platform.

FIG. 3 is a hardware diagram for an implementation of the system.

FIG. 4 is a block diagram showing the process steps of an implemented system.

### DETAILED DESCRIPTION OF THE INVENTION

Example implementations of the disclosed scenarios are described with reference to the attached figures. The figures are not drawn to scale and they are provided merely to illustrate the instant invention. Several aspects are described below with reference to example applications for illustration. It should be understood that numerous specific details, relationships, and methods are set forth to provide a full understanding of the disclosed implementations. One having ordinary skill in the relevant art, however, will readily recognize that the invention can be practiced without one or more of the specific details or with other methods. In other instances, well-known structures or operation are not shown in detail to avoid obscuring the invention. The disclosed implementations is not limited by the illustrated ordering of acts or events, as some acts may occur in different orders and/or concurrently with other acts or events. Furthermore, not all illustrated acts or events are required to implement a methodology in accordance with the disclosed scenarios.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

By the term “personalized” it is meant customization of healthcare using medical decisions, practices, and/or products being tailored to the individual patient.

By the phrase” interactive voice response” (IVR) it is meant automated phone based technology that can be instituted for providing information, gathering survey input, and identifying data points and implementing algorithms for achieving program goals such as decreasing the readmission rate for patients by providing an interactive voice operated intervention to patients in need of such intervention.

In a broad sense, the present invention follows such main drivers as: (a) providing a direct link between the sample medical product and an authorized user's order for such medical product, (b) providing a suite of patient services, (c) providing a mechanism for capturing medical data and linking it to patient status, (d) quantifying the value to provider, and (e) quantifying the value to manufacturer.

Various scenarios described provide an integrated medical product sample system linked to patient services that measure or track acquisition of medical products and further monitor patient compliance with such medical products. The system further allows a user, such as a healthcare provider to use a sample medical product as the initiator of a patient focused process for tracking health activities such as patient's compliance, patient's behavior, and/or incentivizing compliant patient behavior. In another aspect, the present invention provides systems for quantifying the value of providing a sample product to the healthcare provider, monitoring the performance of the healthcare provider as well as assessing the manufacturer's marketing endeavors and strategies.

In one aspect of the invention, a health care provider, such as a physician, is able to assess and demonstrate improvements in the care of a patient via personalized patient metrics as of the date of enrollment of the patient in the integrated medical product sample system. This creates a value for the sample product beyond the medication itself, as the suite of services delivers improvements in adherence, monitoring, etc. thus facilitating improved patient care outcomes.

In another aspect of the invention, as a consequence to performance of the patient while on the sample medical product, the patient may receive an intervention that is designed to optimize or improve health outcome. In one embodiment, upon activation of the system, an initial early intervention may be instituted such as delivery of the prescribed medical product. In another embodiment, the system provides the user an ability to monitor, understand, or assess the overall patient behavior while on a sample medical product and/or throughout a patient specific treatment regimen.

In one aspect, the present invention is a patient-provider driven system that employs for example medication samples as a bridge for assessing healthcare behavior so that all stakeholders (including patients, providers, payers, and manufacturers) benefit from creating and empowering compliant behavior.

In one aspect of the invention, a system for measuring the acquisition of a medical product by a patient is described wherein the system comprises one or more microprocessor components programmed to: (1) receiving a first set of data comprising a tracking code for the medical product and patient specific information, (2) creating an electronic patient specific data file in a database corresponding to the tracking code and the patient information, (3) activating at least one patient care module from a series of patient care modules, wherein said at least one module collects said patient's information from a user and/or said patient, (4) developing personalized patient monitoring parameters, (5) receiving a second set of data comprising information associated to the patient's interaction with one or more of said patient care modules, (6) evaluating the second set of data against the personalized patient monitoring parameters, (7) generating a feedback action plan for the user, wherein said feedback action plan measures patient's adherence to said medical product and/or said patient care modules, and (8) triggering an user authorized intervention. In one embodiment, activation of the system may trigger an initial early intervention such as delivery of the product to the patient. In at least one embodiment, subsequent to developing a personalized patient monitoring parameters, the system triggers a patient care intervention.

One aspect of the present invention is the database for collection of the patient and product specific information. In one embodiment, the database contains a plurality of files, each designated by a unique encrypted alphanumeric sample code corresponding to a sample medical product, such as a wellness kit. As such, each sample product kit used in the system must have a corresponding file in the database that, together with the tracking code, represents the aggregate related information. The sample code may be predetermined by an operator, a user or be randomly generated.

The files in the database contain fields that are capable of being populated with desired information as the corresponding sample medical product, patient information, and other information provided by the user necessary to optimize treatment. In general, the fields may contain information that, for example, the manufacturing company such as a pharmaceutical company would find useful for tracking the sample per acquisition ratio. In another embodiment, the fields may be populated by information relevant to patient's progress on the product and also physician's performance for prescribing the sample product. Examples of such fields may include for example: patient information, drug or device sample prescription quantity available at the health care provider's office, product acquisition matrix, number of refills made or available and patient diagnosis indicators.

In at least one embodiment of this aspect, the medical product used for this system is a pharmaceutical product, a medical device product, a dietary product, a health and fitness product or any combinations thereof. In one embodiment, the medical product is a pharmaceutical product, such as a prescription or non-prescription medication. In one embodiment, the sample medical product may be a “Wellness kit” with the first component providing a direct link between the medication sample and the prescription which is provided through the use of specific identifiers. In at least one embodiment, each sample medication will be linked to a specific patient and a specific prescriber. The identifier can be in the form of a tracking code or other like tracking mechanisms.

In yet another embodiment, the pharmaceutical product is a wellness kit comprising a sample medication, and a tracking code, optionally containing a prescription for said sampled medication. In another embodiment, the patient specific information is selected from the group consisting of patient's demographic information, patient's medical history, patient's diagnosis, patient's medication history, patient's dietary plan, patient's laboratory history, patient's insurance history and any combinations thereof. In another embodiment, the Wellness kit includes a process by which the sample dispensing process initiates a prescription order at the pharmacy dispensing unit which is respectfully processed and subsequently delivered directly to the patient.

In another embodiment, the electronic patient specific data file links the wellness kit to patient care modules. A patient care module as used herein is meant to enable the system to improve clinical outcome by any matrix suitable to assess such outcome. In one embodiment, the patient care modules are configured to perform predetermined functions associated with the first set of data. In such embodiment, the patient care modules are selected from the group consisting of pharmacy module, electronic medical records module, laboratory module, insurance provider module, healthcare provider module, dietary plan module, health-fitness module, reward program module, feedback action plan module, intervention module, user intervention, patient communication modules, patient care plan compliance monitoring modules, and any combinations thereof. In one embodiment, such module may be blinded to the user or the patient.

In yet another embodiment, the user of the system may be a health care provider who interacts with the patient for the purposes of performing a health care service to the patient, a health insurance administrator, a medical product manufacturer, drug manufacturer representative, personal care giver and any combinations thereof as such, the term “user” includes all “healthcare provider,” “physician,” “nurse,” “nurse practioner” “investigator,” “drug manufacturing representative,” “physical therapist” and “health insurance representative.” The term “health care provider” further includes any one of physicians, pharmacists, nurses, nurse practitioners, physician assistants, research assistants, physician's office administrators and any combinations thereof.

In another aspect of the present invention, by the way of a user directly or the accepted medical protocols or patient service modules, the system is capable of generating authorized interventions. Such interventions are electronically configured to be triggered based on user's medical order sets, standard of care guidance rules, quality measures surveillance, pharmacy operated plan of care, and any combinations thereof when certain monitoring parameters reach a predefined threshold. On the other hand, such interventions may be preprogramed within the system, such as post system activation of a prescribed medication.

In one embodiment, the authorized intervention can be any one of a phone call, a SMS text message, a voice message, a facsimile reminder, a computer message, an e-mail, a change in therapy, a scheduling of a home care visit, an office appointment, an offer to participate in education activities, a reward for positive healthcare behavior, a referral to admission to health care facility or any combinations thereof.

In another aspect of the present invention, the system provides specific users; such as a manufacturer representative or a health insurance administrator, a mechanism to assess performance of another user, such as a healthcare provider. For example, a user such as a drug manufacturer representative or a health insurance administrator can track conversion of a medication sample to medication acquisition. In another embodiment, the activation of system enables a health insurance administrator to measure the performance of a health care provider by observing patient monitoring parameters.

In one embodiment, the manufacturer or seller of the medical product can access the measurements in the increased sales of the product, such as increased market share and prescription volume resulting from formulary preference, payor behaviors, and prescriber preference directly attributable to the combination of the sample product within the wellness kit. This is quantified in the incremental sales gains over baseline once the kit is put into use. Alternatively the value can further be quantified by the reduction in sampling costs as less samples are required to generate a prescription.

In another aspect of the present invention, series of method steps are performed by an electronic circuit for tracking sample medical products. In such embodiment, a method is provided that comprises (1) providing to a patient a sample medical product kit comprising a sample medical product and a corresponding tracking code, (2) receiving a first set of data comprising the tracking code of the medical product and patient specific information, (3) creating an electronic patient specific data file in a database corresponding to the tracking code and the patient information, (4) activating a series of patient care modules, wherein each one of said modules collects said patient information from a user and/or said patient, (5) developing personalized patient monitoring parameters, (6) receiving a second set of data comprising information associated to the patient's interaction with the one or more of said patient care modules, (7) evaluating the second set of data against the personalized patient monitoring parameters, and (8) generating a feedback action plan for the user, wherein said feedback action plan measures patient's adherence to said medical product. In at least one exemplary embodiment, the method further includes the step of (9) triggering an user authorized intervention, previously programmed into the system. In one embodiment, all process steps are triggered and further processed by one user. In yet another embodiment, the system prompts the need for a second user to take an action to complete the process.

In another aspect of the invention, upon the activation step, a patient specific profile is generated and further linked to preauthorized series of patient care modules facilitates adding of new content to the electronic patient specific data file by encrypting the new content into an existing string of electronic computer codes. In one exemplary embodiment, the method employs a database having a computer operated management component that assigns medical product's tracking code to an electronic patient specific data file which corresponds to the product's tracking code.

In another embodiment, the medical product contains a pharmaceutical product, prescription or non-prescription medication, a medical device product, a dietary product, a health and fitness product or any combinations thereof. In one exemplary embodiment, the medical product is a kit such as a wellness kit that contains a sample pharmaceutical product, a tracking code for the kit and optionally a prescription or a medical order for said sample pharmaceutical product or other patient care activity. As such upon activating the system via the tracking code, an electronic patient specific data file is generated, such as a prescription data file.

As such instructions may be provided to link the patient specific prescription data file to preauthorized or pre-determined patient care modules. In one embodiment, the patient specific identification information is selected from the group consisting of patient's demographic information, patient's diagnosis, patient's prescription drugs, patient's dietary plan, patient's laboratory results, patient's medical history, patient's insurance history and any combinations thereof. At the same time, instructions are provided within the system wherein each of the patient care modules is configured to perform predetermined functions associated with the first set of patient data.

Typically, the patient care modules are those such as pharmacy module, electronic medical records module, laboratory module, insurance provider module, healthcare provider module, dietary plan module, health-fitness module, reward program module, feedback action plan module, intervention module, or any combinations thereof. Each module can then be accessed by the same or a different user such as a health care provider who interacts with the patient for the purposes of performing a health care service. As described above, the health care provider can be any one of a physician, a pharmacist, a nurse, a nurse practitioner, a physician assistant, a research assistant, a physician's office administrator and any combinations thereof. Such users typically dispense the actual medical sample product and activate the system. In one embodiment, the second user may be a health insurance administrator, or a product manufacturer representative.

In one embodiment, the claimed process generates authorized interventions that are designated to the patient's specific profile by any one of the mentioned users. These authorized interventions can be provided in accordance to a user's medical order sets, standard of care guidance rules, quality measures surveillance, and pharmacy operated plan of care, and any combinations thereof. Upon detecting that at least one patient designated monitoring parameter has reached a predetermined threshold, the present claim methodology executes the instructions for generating a personalized patient intervention including a phone call, a SMS text message, a voice message, a facsimile reminder, a computer message, an e-mail, a change in therapy, a scheduling of a home care visit, an office appointment, an offer to participate in education activities, a reward for positive healthcare behavior, or any combinations thereof.

In yet another embodiment, the platform can track patient fulfillment of a personalized therapeutic regimen initiated by the dispensing of the Wellness kit. Patient may receive IVR reminders that a prescription is ready for pick up or that patient is due for a new refill or that patient has not or picked up a refill within a predetermined timeframe. Upon filling of prescriptions at retail pharmacy, National Counsel for Prescription Drug Programs (NCPDP) information will be captured in real time, and patient will receive a message (IVR and/or instant SMS text message) with health information and/or date for follow up visits.

For example, a patient receives medical product sample kit from a healthcare provider user. Once system activated, administrators of the site can authorize and schedule interventions for users including IVR calls, text messages, e-mails, faxes, and “live” phone calls from call center representatives. Such interventions can be scheduled, manually or automatically through software, in any combination and frequency, individually for a distinct user or in the form of predetermined templates, based on the user data entered into the platform or imported from a database such as an electronic medical record, accepted medical practice guidelines or health insurance provider.

In one embodiment, kit activation and prescription fulfillment by a pharmacy unit is provided. In one embodiment, the kit activates a set of patient and provider services including but not limited to product discounts, patient education, medication adherence support, reimbursement assistance, access to “live” patient support, and feedback to the physician, patient and/or caregiver.

In another embodiment, the present invention provides for data capture and linkage with precompiled medical data obtainable from other resources, such as electronic medical records, health insurance provider data bank, prior hospital admissions, medication distribution data, or the like. In another embodiment, the combined data sets will allow the creation of a link between the initial medication sample and clinical metrics indicative of changes in patient status that serve as markers for desired patient outcomes.

In at least another embodiment, the present invention provides a value in monitoring patient measurements. In one embodiment, the system provides medication samples to patients to facilitate initiation of therapy and long term success with therapy resulting from improved knowledge of medication and disease, improved adherence, and ongoing support services. As such, in at least one embodiment, the system offers a simplified medication acquisition to address insurance coverage and reimbursement issues such as prior authorizations. In yet another embodiment, patients experience additional convenience resulting from assistance with medication access and follow up refills.

In yet another embodiment, the present invention provides patient specific modules, so that patients themselves have access to services such as a support hotline available to answer questions provides additional peace of mind or availability of discounts and co-pay assistance to reduce out-of-pocket costs.

In another embodiment, the present invention improves the healthcare quality and outcomes for patients enrolled in the program by the way of providing feedback to health care providers. In one embodiment, the feedback is used to improve the quality of drug therapy. In yet another embodiment, health care providers and health insurance payors benefit from reduced cost of care resulting from adherence to a therapeutic regimen and proper medication use.

In yet another embodiment, the healthcare provider may obtain access to additional data that is used in analyzing patient outcomes and the provider's performance.

In yet another aspect, the invention provides significant value to manufacturer by the way of directly linking the marketing activities and cost of distributing sample medical products to actual acquisition of the sampled product. For example, in one embodiment, the system facilitates a 1:1 sample to prescription ratio, which signifies the maximum return on investment for the sampling of medication. In another embodiment, the system provides the manufacturers a tool for accurate market research, particularly related to prescriber and patient activities.

In another embodiment, the instantly claimed invention provides an additional marketing tool for the manufactures to promote brand based patient loyalty through added value programs. In one embodiment, brand recognition through the methods implemented limits or disincentivizes the switching of a brand to generic or other competitive product through first fill from a participating pharmacy due to the value of the services directly associated with the brand product. In another embodiment, the present invention creates and incorporates a process for automated inventory control at the prescriber level by including a tracking code on each sample that is registered by the system and associated with an individual prescriber.

Exemplary Systems

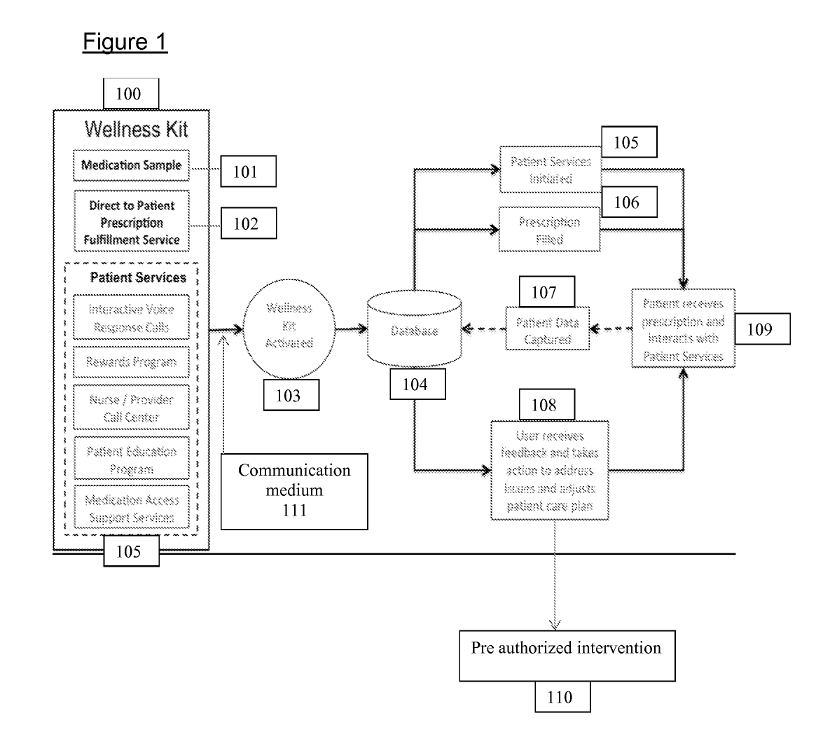

FIGS. 1- 4 illustrate non-limiting embodiments of the general design of the present system. In FIG. 1, for example, a wellness kit 100 containing a tracking component, such as a tracking code and a sample prescription medication 101 is provided. The tracking code allows for directly linking the kit containing a medication sample to a prescription and a patient. The wellness kit also provides the option of linking said kit to a suite of patient services or modules 102. Once activated, 103, the system registers said kit and patient specific information in a database operated by a computerized management system and triggers the pharmacy module to fill 106 and dispense the prescribed medication by directly interacting with the patient 109. The database management as instructed then captures relevant data concerning the dispensing to and interacting with the patient, thereby providing feedback to a user for taking necessary steps to optimize the patient care plan 108. Such steps can be predetermined, preauthorized or preprogramed into the management data system, thereby triggering an authorized patient intervention 110.

In one aspect of the present invention, the presented system provides for a user module, which enables a user such as a healthcare provider, i.e. a physician. Such user module enable the healthcare provider to dispense a medical product sample kit and activate the system through communication mediums 111 via a computing apparatus/device for operating for example a web browser. The activation step can be performed by the way of a prescription being submitted through an electronic prescribing software platform, a facsimile, a phone call from the prescriber, or alike to activate pharmacy module. The computing apparatus/device is such that it enables the user to remotely access the system, for example the web site, through the communication medium such as the web, telephone line, wireless communications or the like to further monitor patient's progress on the prescribed therapeutic regime. Examples of the computing apparatus/device include a desktop computer, a lap top computer, a personal digital assistant, a computing tablet, an interactive wireless communications device, a handheld computer, a computer server, or the like, which connects with the communication medium. Additionally, the computing apparatus/device may include any one of peripheral devices that is linked or cooperates with the computing apparatus/device, such as a printer, a scanner, a bar code scanner, facsimile machine and the like.

In another aspect of the invention, a pharmacy module is employed to receive actual prescription orders from a computer management system and then routes them to the appropriate processor for proper function. Once activated by a health care provider the system may prompt through the pharmacy module a series of instructions requiring input from a pharmacy unit. Once appropriate instructions are executed a personalized patient profile is generated that is able to be linked to other patient care service/modules. The system also provides for the user an access to update patient care plan further allowing health outcome measurements. In one embodiment, a single user such as a health care administrator from physician's office, hospital, a pharmacy can activate the system to execute all process steps in an automated process. According to this embodiment, other users may be prompted remotely to take necessary actions to activate a given service module.

In one embodiment, the user is a pharmacist that activates the system upon receiving a tracking code for the sample medicinal product or a wellness kit. As such, the user identifies patient specific information for the purpose of interacting with the system by the way of a tracking code or device that is preassigned to the sample medication product or kit. Once activated, 104, the system captures the user and the patient's data into a database 105 which can be used for activation of various patient modules 105, each of which may trigger a separate series of instructions specific to said module. This information may be stored in a database 105.

In at least one embodiment the patient has the ability to interact with the system directly to provide specific preassigned monitoring parameter at a pharmacy, such as filling a prescription 107, in conjunction with optionally activating other health care modules. Patient compliance is then assessed based on series of patient data capture 107 and run against series of predetermined monitoring parameters. Upon comparison of the monitoring parameters and patient specific data captured, the system triggers an intervention in any form found appropriate 110.

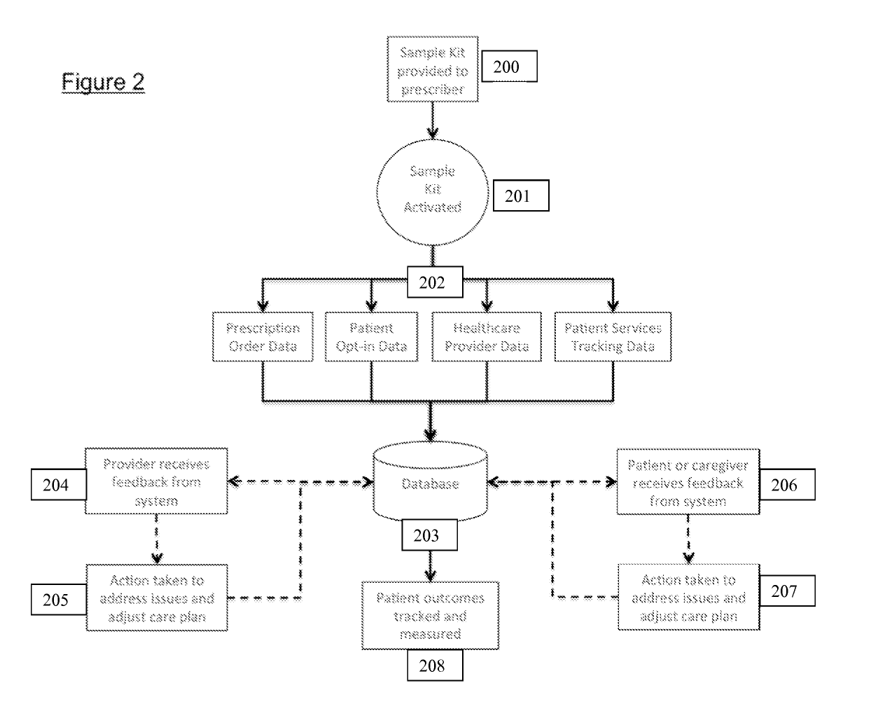

Referring now to Figure. 2, there is provided a flow chart that illustrates an alternative design of the disclosed system. Accordingly, a user such as a physician or a physician's office staff, initiates the system by providing a sample medication to a patient and activating the system, 200, 201. The actual activation step is through transmission of a collective set of data combined or paired together, which may then be split into different transmissions at the computer management system level 202, with the prescription order data, patient opt-in data, healthcare provider data and patient services tracking data, being submitted for delivery to the chosen pharmacy services. Data respectively stored in designated pharmacy services 203 enabling feedback loops to the users and patients.

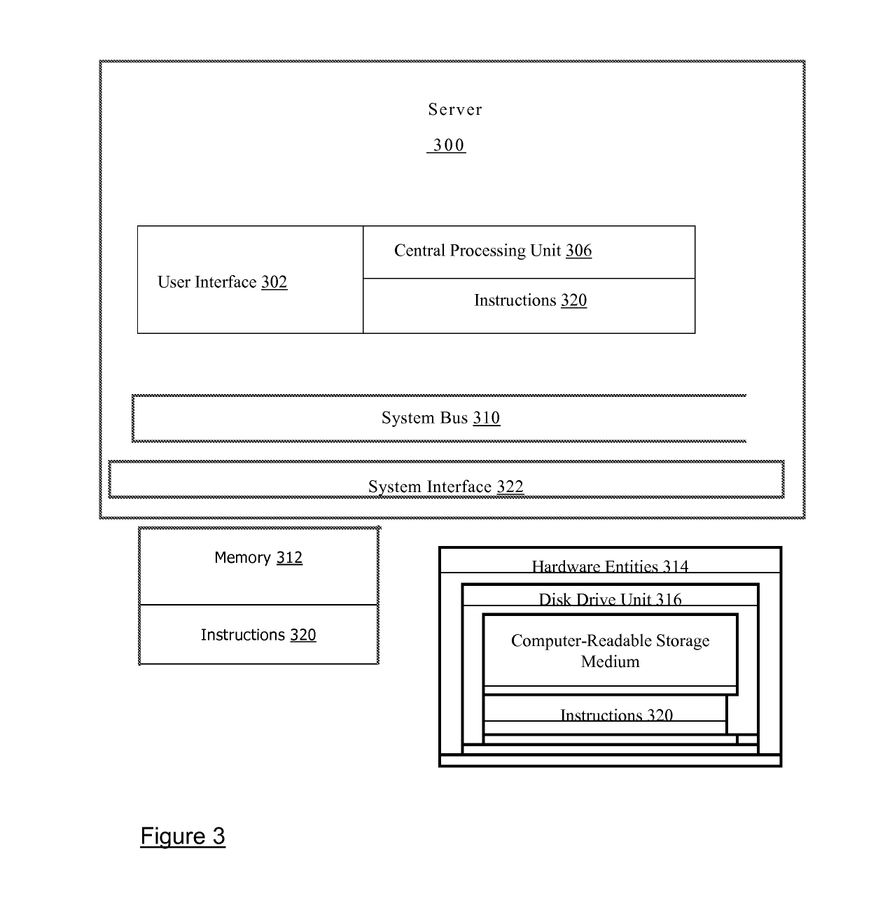

FIG. 3 provides a more detailed block diagram of the server 300. As shown in FIG. 3, the server 300 comprises a system interface 322, a user interface 302, a Central Processing Unit (CPU) 306, a system bus 310, a memory 312 connected to and accessible by other portions of server 300 through system bus 310, and hardware entities 314 connected to system bus 310. At least some of the hardware entities 314 perform actions involving access to and use of memory 312, which can be a Random Access Memory (RAM), a disk driver and/or a Compact Disc Read Only Memory (CD-ROM). Some or all of the listed components 302-322 can be implemented as hardware, software and/or a combination of hardware and software. The hardware includes, but is not limited to, an electronic circuit.

The server 300 may include more, less or different components than those illustrated in FIG. 3. However, the components shown are sufficient to disclose an illustrative embodiment implementing the present invention. The hardware architecture of FIG. 3 represents one embodiment of a representative server configured to facilitate the provision of services to a user of a communication device.

Hardware entities 314 can include microprocessors, Application Specific Integrated Circuits (ASICs) and other hardware. Hardware entities 314 can include a microprocessor programmed for facilitating the provision of the automatic software function control services to a user of the communication device. In this regard, it should be understood that the microprocessor can access and run various software applications (not shown in FIG. 3) installed on the server 300. Such applications can facilitate different health service or patient care modules, health insurance data and electronic patient history.

As shown in Figure, the hardware entities 314 can include a disk drive unit 316 comprising a computer-readable storage medium 318 on which is stored one or more sets of instructions 320 (e.g., software code or code sections) configured to implement one or more of the methodologies, procedures, or functions described herein. The instructions 320 can also reside, completely or at least partially, within the memory 312 and/or within the CPU 306 during execution thereof by the server 300. The memory 312 and the CPU 306 also can constitute machine-readable media. The term “machine-readable media”, as used here, refers to a single medium or multiple media (e.g., a centralized or distributed database, and/or associated caches and servers) that store the one or more sets of instructions 320. The term “machine-readable media”, as used here, also refers to any medium that is capable of storing, encoding or carrying a set of instructions 320 for execution by the server 300 and that cause the server 300 to perform any one or more of the methodologies of the present disclosure.

System interface 322 allows the server 300 to communicate directly or indirectly with external communication devices. If the server 300 is communicating indirectly with the external communication device, then the server 300 is sending and receiving communications through a common network.

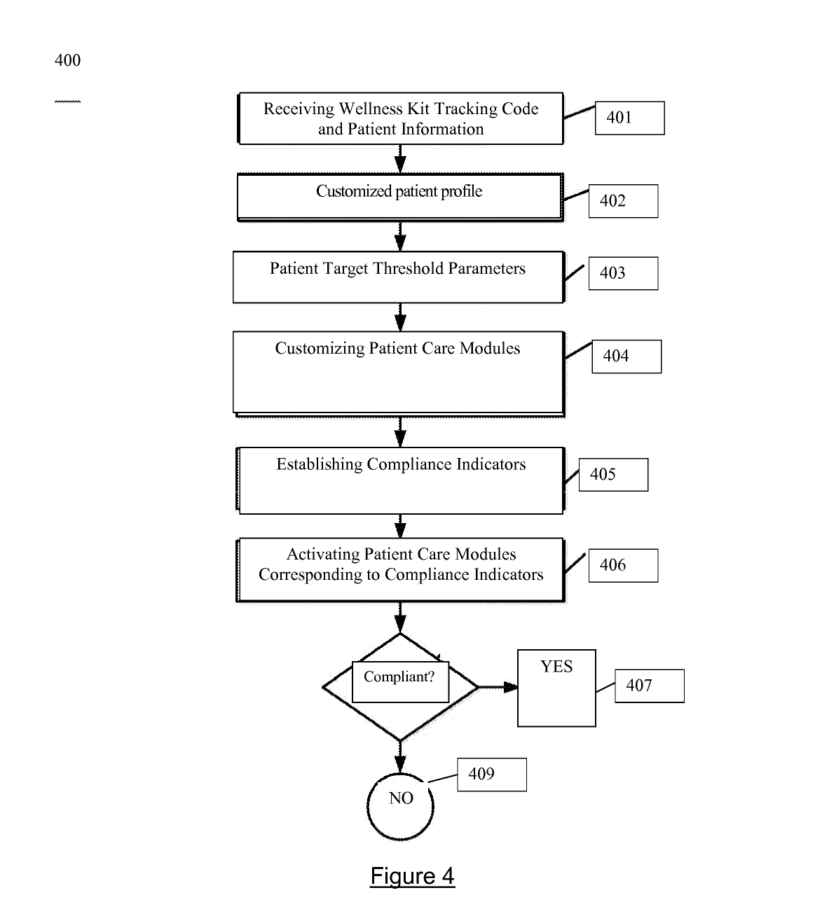

Referring now to Figure. 4, a flow chart is provided of a scenario for a method 400 of the disclosed platform of the system. The platform receives sample medical product kit tracking information and patient identifying information 401. In an example, the tracking code may be a number, a code, a scanning bar, or a chip while the patient identifying information may only include a first and last name and an email address, which would typically be sufficient to individually identify a particular patient. Additional detailed information, such as that relevant to the patient's medical status, may also be included without limitation. From the patient identifying information, the platform generates a personalized patient profile 402.

The patient profile may include both public and non-public (i.e. private) components. The public patient profile includes profile information which is visible to healthcare providers or health insurance users registered on the platform or any user accessing the website. The site owner or any given user may decide to restrict access to profile information to only registered users or may allow public information to be freely accessible without registration.

The private profile may include more sensitive information including the patient's medical history and the like. The private profile may only be accessible by the patient and other privileged users which obtain the patients permission in exchange for access to the private profile data. For example, a patient may wish to allow his/her primary care physician to have access to the private profile data.

The platform also receives patient care target thresholds 403. Patient care target thresholds identify particular conditions, clinical outcomes, proposed diet regimen, and/or medications compliance associated with the patient. For example, the patient may have type I diabetes and have a prescription for insulin. Both “type I diabetes” and “insulin” are each patient care target thresholds. Each may be represented by a code or other indicator which the platform can use to identify compliance or non-compliance.

Using the profile data and patient care target thresholds, the platform generates a personalized patient care plan that includes one or more patient care modules 404. Various combinations of patient profile data and patient care target thresholds may suggest particular patient care modules to be included in the patient care plan. For example, if a patient leaves a physician's office with a blood pressure medicine wellness kit, either the physician's administrator or a participating pharmacy can activate the system. In the scenario that a pharmacist at a participating pharmacy activates the system, the sample medication to acquisition of the product is indeed 1:1. As such when the prescribed medication is registered within the patient's profile, the platform may generate a patient care plan with a preauthorized intervention through, the physician's office itself, or through an accepted medical care plan or a health care provider's approved standard of care protocol. A patient care plan may include a follow up office visit within a set amount of time. The office visits schedule may represent another patient care module for the patient to comply with. Educational modules designed to inform the patient on the importance of taking the prescribed medication may also be included. Other examples of patient care modules include a suggested dietary regimen, a suggested fitness regimen, and/or any other activity or course of action which is recommended and/or assigned to the patient by a user.

The platform may also contain one or more compliance indicators 405. A compliance indicator is data that indicates whether the patient has complied with a particular patient care module upon activation of the wellness kit. For example, if the patient is supposed to visit his or her physician within two weeks of activation of the wellness kit, data may be received with indicates whether the patient has or has not complied with such visit. The indicator may also be an absence of data, e.g. that no data has been received indicating the prescription has been filled or refilled. In either case, the platform receives an indication that at least some portion of the module has not been complied with.

Using the compliance indicators, the patient's compliance with a patient care module and/or a patient care plan is assessed 406. As used in this document, compliance means that the patient has engaged in an optimal activity. For example, if the patient is supposed to fill a prescription within a set amount of time, the patient is compliant if the prescription is filled within the amount of time given. The patient is not compliant (i.e., non-compliant) if the prescription has not been filled within the amount of time given. If the patient is compliant (407: Yes), the platform may send a report to the secondary user such as an health insurance administrator or a product manufacturing representative as to the effectiveness of the regimen for such patient. If, however, the patient is not compliant (408: No), an appropriate authorized intervention may be instituted by placing notifications on the platform website, sending an SMS message, sending an email, placing an IVR phone call, sending a fax, contacting health care provider and the like. If the non-compliance is determined to be critical, the platform performs an provider defined intervention for critical activities.

While the present invention has been described with reference to certain embodiments, it will be understood by those skilled in the art that various changes may be made and equivalents may be substituted without departing from the scope of the present invention. In addition, many modifications may be made to adapt a particular situation or material to the ‘teachings of the present invention without departing from its scope. Therefore, it is intended that the present invention not be limited to the particular embodiment disclosed, but that the present invention will include all embodiments falling within the scope of the appended claims.

1. A system for measuring the acquisition of a medical product by a patient comprising one or more microprocessor components programmed to: (1) receiving a first set of data comprising a tracking code for the medical product and patient specific information, (2) creating an electronic patient specific data file in a database corresponding to the tracking code and the patient information, (3) activating at least one patient care module from a series of patient care modules, wherein said at least one module collects said patient's information from a user and/or said patient, (4) developing personalized patient monitoring parameters, (5) receiving a second set of data comprising information associated to the patient's interaction with one or more of said patient care modules, (6) evaluating the second set of data against the personalized patient monitoring parameters, (7) generating a feedback action plan for the user, wherein said feedback action plan measures patient's adherence to said medical product and/or said patient care modules, and (8) triggering an user authorized intervention.

2. The system of claim 1, wherein step 4 further triggers a patient care intervention.

3. The system of claim 1, wherein said medical product is a pharmaceutical product, a medical device product, a dietary product, a health and fitness product or any combinations thereof.

4. The system of claim 2, wherein the medical product is a pharmaceutical product.

5. The system of claim 3, wherein the pharmaceutical product is a wellness kit comprising a sample medication, and a tracking code.

6. The system of claim 3, wherein the wellness kit further comprise a prescription for said sample medication.

7. The system of claim 5, wherein the electronic patient specific data file links the wellness kit to patient care modules.

8. The system of claim 1, wherein the patient specific information is selected from the group consisting of patient's demographic information, patient's medical history, patient's diagnosis, patient's medication history, patient's dietary plan, patient's laboratory history, patient's insurance history and any combinations thereof.

9. The system of claim 1, wherein each of the patient care modules is configured to perform predetermined functions associated with the first set of data.

10. The system of claim 9, wherein the patient care modules are selected from the group consisting of pharmacy module, electronic medical records module, laboratory module, insurance provider module, healthcare provider module, dietary plan module, health-fitness module, reward program module, feedback action plan module, intervention module, user intervention, patient communication modules, patient care plan compliance monitoring modules, and any combinations thereof.

11. The system of claim 1, wherein the user is selected from the group consisting of a health care provider who interacts with the patient for the purposes of performing a health care service to the patient, a health insurance administrator, a medical product manufacturer, drug manufacturer representative, personal care giver and any combinations thereof.

12. The system of claim 9, wherein the health care provider is selected from the group consisting of physician, pharmacist, nurse, nurse practitioner, physician assistant, research assistant, physician's office administrator and any combinations thereof.

13. The system of claim 12, wherein the medical product manufacture representative is a drug manufacturer representative.

14. The system of claim 1, wherein the authorized intervention comprise user's medical order sets, standard of care guidance rules, quality measures surveillance, pharmacy operated plan of care, and any combinations thereof.

15. The system of claim 12, wherein the authorized intervention comprises a phone call, a SMS text message, a voice message, a facsimile reminder, a computer message, an e-mail, a change in therapy, a scheduling of a home care visit, an office appointment, an offer to participate in education activities, a reward for positive healthcare behavior, a referral to admission to health care facility or any combinations thereof.

16. The system of claim 2, wherein the user is a drug manufacturer representative.

17. The system of claim 11, wherein the drug manufacturer representative further measures medication sample to prescription ratio and/or the performance of a health care provider.

18. The system of claim 4, wherein the user is a health care provider.

19. The system of claim 16, wherein the health care provider measures the efficacy of the medication sample and/or patient's compliance with said medication.

20. A method performed by an electronic circuit for tracking sample medical products, the method comprising (1) providing to a patient a sample medical product kit comprising a sample medical product and a corresponding tracking code, (2) receiving a first set of data comprising the tracking code of the medical product and patient specific information, (3) creating an electronic patient specific data file in a database corresponding to the tracking code and the patient information, (4) activating a series of patient care modules, wherein each one of said modules collects said patient information from a user and/or said patient, (5) developing personalized patient monitoring parameters, (6) receiving a second set of data comprising information associated to the patient's interaction with the one or more of said patient care modules, (7) evaluating the second set of data against the personalized patient monitoring parameters, and (8) generating a feedback action plan for the user, wherein said feedback action plan measures patient's adherence to said medical product.
